(19) United States
(12) Patent Application Publication
(10) Pub. No.: US 2017/0162844 A1
(43) Pub. Date: Jun. 8, 2017

(54) BATTERY DEVICES AND WEARABLE ELECTRONIC DEVICES INCORPORATING SUCH BATTERY DEVICES

(71) Applicant: Intel Corporation, Santa Clara, CA (US)

(72) Inventor: Christopher L. Capener, Cupertino, CA (US)

(21) Appl. No.: 14/959,398

(22) Filed: Dec. 4, 2015

(51) Int. Cl. H01M 2/12; H01M 10/0525; G02B 27/01; G06F 1/16

(52) U.S. Cl. CPC H01M 2/1264; G06F 1/163; G06F 1/1656; H01M 10/0525; G02B 27/017; H01M 2220/30; G02B 2027/0178

(57) ABSTRACT

Examples of battery devices and wearable electronic apparatuses and devices incorporating such devices are provided. More specifically, battery devices that include a partial enclosure that surrounds an end surface of the battery and a plurality of side surfaces of the battery, and defines an opening that at least partially exposes an opposing end surface of the battery, the partial enclosure being configured to vent output of the lithium-ion battery during a thermal runaway event, potentially in a direction away from the wearer or user of a wearable electronic device or apparatus, are described. The partial enclosure may be made of a copper tape or other high melting point material.

### BACKGROUND

Lithium-ion batteries are a prevalent form of batteries used to power electronic devices. One major concern with lithium-ion batteries is an occurrence known as a “thermal runaway event” in which the temperature of a battery increases drastically and ultimately results in flames or gaseous release. These escaping gases and flames from the lithium-ion battery may place people in proximity to devices incorporating such batteries in danger.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A and 1B provide perspective views of an exemplary battery device in a disassembled and assembled construction, respectively, according to at least one example of the present description.

FIG. 2 is a perspective view of a battery device according to at least one example of the present description during a thermal runaway event.

FIG. 3 is a cross-sectional view of a battery device according to at least one example of the present description.

FIGS. 4A and 4B are perspective and front views of a wearable electronic apparatus, respectively, according to at least one example of the present description.

FIG. 5 is a perspective view of a wearable electronic device according to at least one example of the present description.

FIG. 6 is a perspective is a perspective view of a wearable electronic device according to at least one example of the present description.

FIG. 7 is a perspective view of an exemplary battery device according to at least one example of the present description.

### DETAILED DESCRIPTION

As noted, lithium-ion batteries are a commonly used type of battery for providing power to electronic devices. However, lithium-ion batteries suffer the drawback of potential thermal runaway events. Additionally, the market for electronic devices that can be worn by a user (“wearable electronic devices”) is increasing dramatically and lithium-ion batteries can be used to power wearable electronic devices. A thermal runaway event on or in a device worn by a user could result in serious injury or death if it cannot be managed properly (e.g. where gases or flames are vented in the direction of a user). The present description provides for a solution to this issue by providing a battery device that can aid in protecting the user of a wearable electronic device from harm in the event of a thermal runaway event.

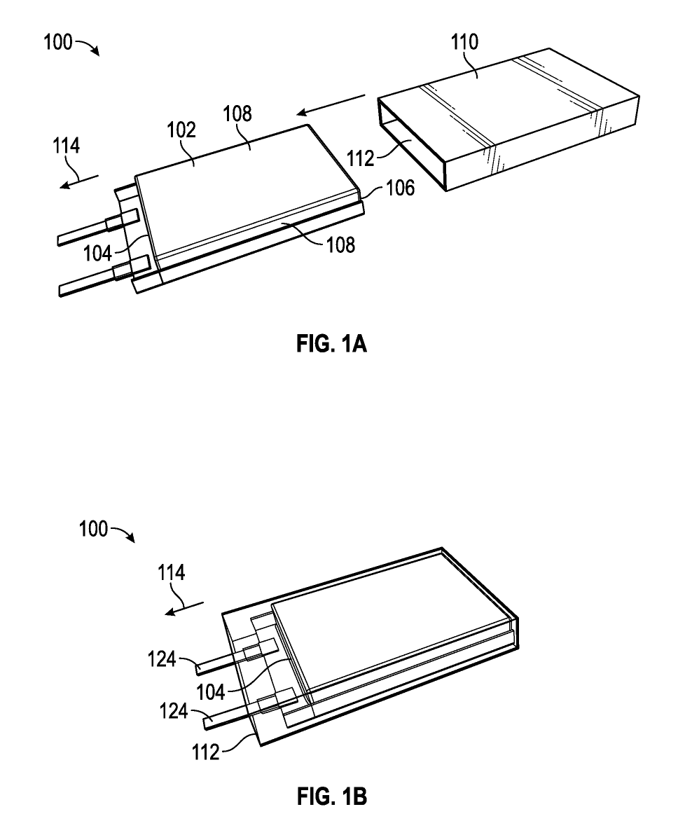

FIGS. 1A and 1B provide perspective views of an exemplary battery device in a disassembled and assembled construction, respectively, according to at least one example of the present description. Battery device 100 may include a battery 102, such as a lithium-ion battery. Battery 102 may include a first end surface 104 and a second end surface 106 that is positioned opposite the first end surface 104. Battery 102 may further include one or more side surfaces 108 that each extend longitudinally between the first end surface 104 and second end surface 106. In an example, a plurality of side surfaces 108 can be provided, such four side surfaces extending between the first end surface 104 and second end surface 106 as illustrated in FIGS. 1A and 1B. However, the battery 102 may have a different number of side surfaces, such as one (in the case of a cylinder), three, five, six, and the like.

Battery device 100 further may include a partial enclosure 110 that surrounds the second end surface 106 and the plurality of side surfaces 108. The partial enclosure 110 may be shaped such that its cross-sectional shape generally matches that of the battery 102. The hollowed out portion of the partial enclosure 110 may be sufficiently large to enable the partial enclosure 110 to surround the majority of the battery 102. The partial enclosure 110 may define an opening 112 that at least partially exposes the first end surface 104. In some examples, the opening 112 may fully expose the first end surface 104. The partial enclosure 110 may be configured to vent output of the battery 102 (e.g. lithium-ion battery) during a thermal runaway event. For example, the presence of the opening 112, along with the positioning of the opening (such that it does not block the first end surface 104), may allow flames or gas associated with a thermal runaway event from battery 102 to vent in a first direction 114.

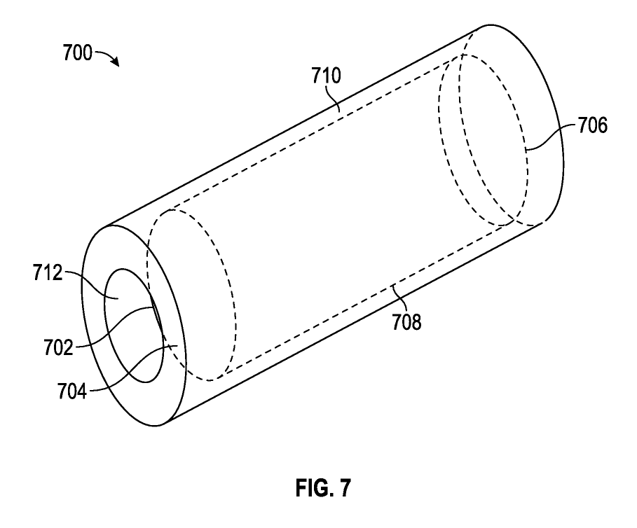

As noted, other shapes of battery and enclosure are also contemplated. For example, a battery device 700 including a cylindrical battery 702 is illustrated in FIG. 7. Battery device 700 further includes a cylindrical partial enclosure 710 surrounding the second end surface 706 and side surface 708 of cylindrical battery 702. The partial enclosure 710 can define an opening 712 that at least partially exposes the first end surface 704 of battery 702. In addition, as opposed to battery device 100 in which opening 112 fully exposes first end surface 104, in the present example, opening 712 only partially exposes first end surface 704.

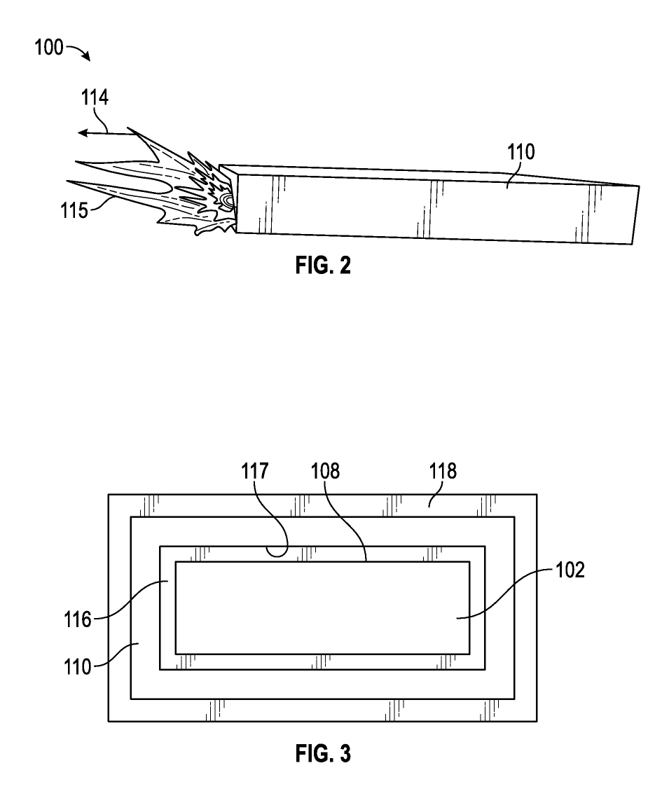

FIG. 2 provides an illustration of a thermal runaway event, such as an event that battery 102 might experience. As illustrated, partial enclosure 110 direct the flames 115 from thermal runaway event in direction 114. In an example, the partial enclosure 110 may be made, at least in part, of a copper tape. Alternatively, the partial enclosure 110 may be made of other materials, e.g., a ceramic cloth or panel, stainless steel or titanium. Regardless of the type of material, it may be desirable that the partial enclosure 110 has a high melting point, such that it can withstand melting at the temperatures associated with a thermal runaway event. For example, the partial enclosure 110 may be made of a material having a melting point of greater than 800 degrees Celsius, greater than 900 degrees Celsius, or greater than 1000 degrees Celsius, etc.

In an example, as shown in FIG. 3, the partial enclosure 110 (formed from copper tape, for example) may include an adhesive layer 116 that is positioned on the interior walls 117 of the partial enclosure 110 and is capable of adhering the partial enclosure 110 to the battery 102. In at least some examples of a copper tape enclosure, copper tape may be originally provided in sheet form. In such an example, the copper tape may be cut to the appropriate size and shape, and folded around the battery 102 with adhesive layer 116 securing the copper tape to the battery 102. Additionally, or alternatively, the partial enclosure 110 can be formed using drawing or folding and welding methods.

Additionally, in some examples, as the copper tape is conductive and may get very hot during a thermal runaway event (or in other instances), the battery device 100 may additionally include an insulating layer 118 that at least partially surrounds the partial enclosure 110. Insulating material may preferably be very low conductivity material, and potentially a light weight material. In some example, the battery device 100 may be configured to be operatively coupled to a wearable electronic device. In such an example, the opening 112 may be configured to be oriented in a direction opposite a wearer of the electronic device (i.e. direction 114 is opposite a wearer of the device), such that upon coupling of the battery device to a wearable electronic device, the opening of the partial enclosure is oriented such that the output of the lithium-ion battery can be vented in a direction away from the user.

As further shown in FIG. 1B, the opening 112 may be surround the end surface 104 of the battery 102 at which electric leads 124 connect to the battery 102. The opening 112 may be configured to allow the electric leads 124 to pass therethrough.

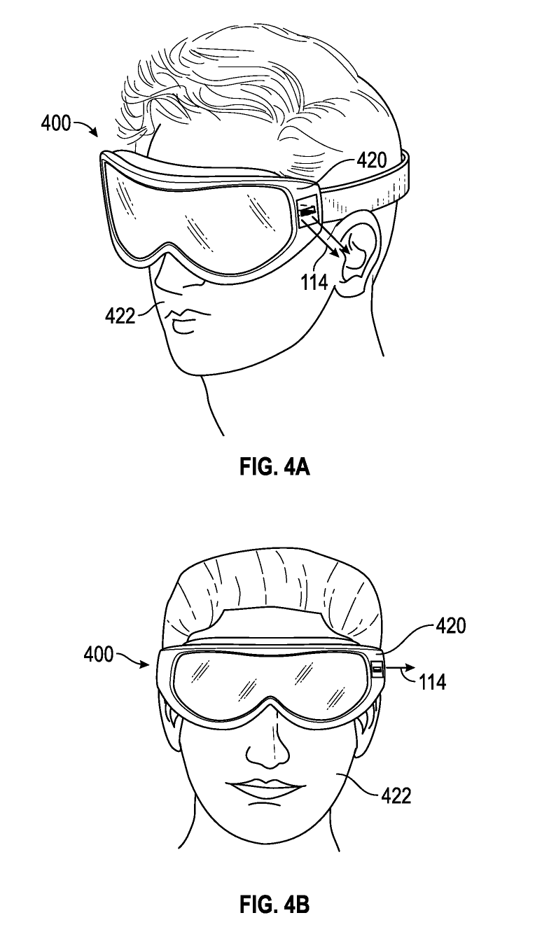

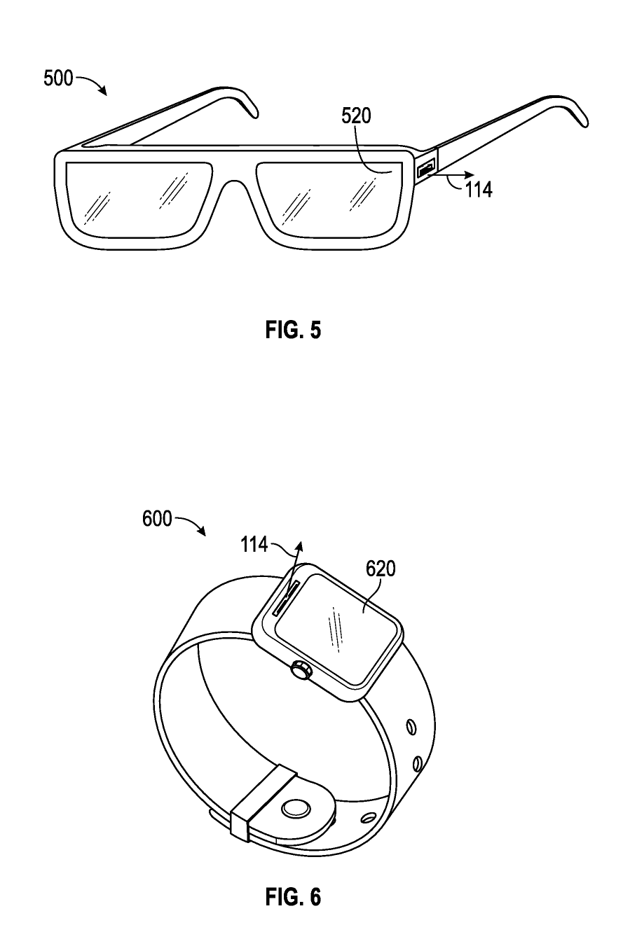

In another aspect, the present description relates to a wearable electronic apparatus. One example of such an apparatus is provided in FIGS. 4A and 4B. The wearable electronic apparatus 400 may include an electronic device 420 that is configured to be worn on the body of a user 422. The wearable electronic device 420 may further include a battery device 100 (with similar features to battery device 100 described above) that is configured to be operatively coupled to the electronic device 420 and provide power to the electronic device 420. Again (as shown in FIGS. 1A and 1B), the battery device 100 may include a battery 102, such a lithium-ion battery, and a protective enclosure 110 partially enclosing the battery 102. The protective enclosure 110 may enclose each side of the battery 102 except an end surface 104 that faces generally away from the user 422 (i.e. in a direction 114).

The wearable electronic apparatus 400 may, in some examples, be a head-mounted device. For example, the wearable electronic device 420 include a heads-up display, such as a virtual reality headset or glasses (e.g., glasses 520 of FIG. 5 showing venting direction 114 of apparatus 500 away from the wearer). Alternatively, as shown in FIGS. 4A and 4B, the wearable electronic device 420 may be glasses or goggles, such as ski goggles with electronic functionality (e.g., audio, video/heads up display, etc.). Alternatively, the wearable electronic device 420 can be a wrist-mounted device, such as a smart watch, GPS system, step-count tracker, heart-rate monitor, devices incorporating all of these functions, and the like. An exemplary wrist-mounted device 620 is provided in FIG. 6 (with venting direction 114 of wearable apparatus 600 away from wearer of device). Other wearable electronic devices that can be mounted on the head, wrist, or other parts of the body that may require a lithium-ion battery power source are also contemplated.

In another example, the present description relates to a wearable electronic apparatus (such as apparatus 400) that includes an electronic device configured to be worn on the body of a user (for example a wrist mounted or head-mounted electronic device, like device 420). The apparatus may further include a means for providing power to the electronic device. Means for providing power can include, e.g., batteries, such as lithium-ion batteries, fuel cells, and the like. The apparatus may also include a means for containing and directionally venting away from the user of the device the gas or flames associated with a thermal runaway event from the means for providing power to the electronic device. The means for containing and directionally venting can include enclosures having high melting temperatures, such as copper tape enclosures, ceramic cloth or panel enclosures, stainless steel enclosures, titanium enclosures, and the like. The means for containing and directionally venting will generally include at least one opening proximate the powering means, the opening facing in a direction away from a user.

### ADDITIONAL NOTES & EXAMPLES

Example 1 is a battery device, comprising: a lithium-ion battery comprising: a first end surface; a second end surface; and a plurality of side surfaces extending longitudinally between the first end surface and the second end surface; and a partial enclosure that surrounds the second end surface and plurality of side surfaces, the partial enclosure defining an opening that at least partially exposes the first end surface, the partial enclosure comprising a copper tape and being configured to vent output of the lithium-ion battery during a thermal runaway event.

In Example 2, the subject matter of Example 1 optionally includes wherein the battery device is configured to be operatively coupled to a wearable electronic device.

In Example 3, the subject matter of Example 2 optionally includes wherein upon coupling of the battery device to the wearable electronic device, the opening of the partial enclosure is oriented such that the output of the lithium-ion battery can be vented in a direction away from a wearer of the wearable electronic device.

In Example 4, the subject matter of any one or more of Examples 1-3 optionally include wherein the copper tape comprises an adhesive layer that is adhered to the side surfaces of the lithium-ion battery.

In Example 5, the subject matter of any one or more of Examples 1-4 optionally include further comprising an insulating layer at least partially surrounding the partial enclosure.

In Example 6, the subject matter of any one or more of Examples 1-5 optionally include wherein the plurality of side surfaces include four side surfaces extending between the first end surface and second end surface.

Example 7 is a wearable electronic apparatus, comprising: an electronic device configured to be worn on a body of a user; and a battery device configured to be operatively coupled to the electronic device and provide power to the electronic device, the battery device comprising: a lithium-ion battery having a first end surface, a second end surface, and a plurality of side surfaces;

and a protective enclosure partially enclosing the lithium-ion battery, the protective enclosure surrounding the second end surface and the plurality of side surfaces, while leaving the first end surface at least partially exposed.

In Example 8, the subject matter of Example 7 optionally includes wherein the protective enclosure comprises copper tape.

In Example 9, the subject matter of any one or more of Examples 7-8 optionally include wherein the protective enclosure comprises a ceramic cloth or panel.

In Example 10, the subject matter of any one or more of Examples 6-9 optionally include wherein the protective enclosure includes a material having a melting point of greater than 800 degrees Celsius.

In Example 11, the subject matter of any one or more of Examples 7-10 optionally include wherein the protective enclosure includes a material having a melting point of greater than 1,000 degrees Celsius.

In Example 12, the subject matter of any one or more of Examples 7-11 optionally include wherein the electronic device is a head-mounted device.

In Example 13, the subject matter of Example 12 optionally includes, wherein the head-mounted device comprises a heads-up display.

In Example 14, the subject matter of any one or more of Examples 12-13 optionally include wherein the head-mounted device comprises ski goggles.

In Example 15, the subject matter of any one or more of Examples 12-13 optionally include wherein the head-mounted device comprises glasses.

In Example 16, the subject matter of any one or more of Examples 7-15 optionally include wherein the electronic device is a wrist-mounted device.

In Example 17, the subject matter of any one or more of Examples 7-16 optionally include further comprising an insulating material at least partially surrounding the enclosure.

In Example 18, the subject matter of any one or more of Examples 7-17 optionally include further comprising electric leads, the electric leads connecting to the first end of the lithium-ion battery.

In Example 19, the subject matter of Example 18 optionally includes wherein the protective enclosure defines an opening that allows the electric leads to pass therethrough.

In Example 20, the subject matter of any one or more of Examples 7 and 10-19 optionally includes wherein the protective enclosure comprises stainless steel.

In Example 21, the subject matter of any one or more of Examples 7 and 10-19 optionally includes wherein the protective enclosure comprises titanium.

Example 22 is a wearable electronic apparatus comprising: an electronic device configured to be worn on a body of a user; and a means for providing power to the electronic device; and a means for containing and directionally venting away from the user of the device the gas or flames associated with a thermal runaway event from the means for providing power to the electronic device.

In Example 23, the subject matter of Example 22 optionally includes wherein the electronic device comprises a head-mounted device.

In Example 24, the subject matter of any one or more of Examples 21-23 optionally include wherein the electronic device comprises a wrist-mounted device.

In Example 25, the subject matter of any one or more of Examples 21-24 optionally include wherein the means for containing and directionally venting comprises copper tape, ceramic cloth or panel, stainless steel or titanium.

In Example 26, the subject matter of any one or more of Examples 21-25 optionally include wherein the means for providing power to the electronic device comprises a lithium-ion battery.

Example 27 is a battery device comprising a lithium-ion battery comprising: a first end surface; a second end surface; and a plurality of side surfaces extending longitudinally between the first end surface and the second end surface; and a means for surrounding the second end surface and the plurality of side surfaces with a partial enclosure, the partial enclosure defining an opening that at least partially exposes the first end surface, the partial enclosure comprising a copper tape and being configured to vent output of the lithium-ion battery during a thermal runaway event.

In Example 28, the subject matter of Example 27 optionally includes wherein the battery device is configured to be operatively coupled to a wearable electronic device.

In Example 29, the subject matter of any one or more of Examples 27-28 optionally includes wherein upon coupling of the battery device to the wearable electronic device, the opening of the partial enclosure is oriented such that the output of the lithium-ion battery can be vented in a direction away from a wearer of the wearable electronic device.

In Example 30, the subject matter of any one or more of Examples 27-29 optionally include wherein the copper tape comprises an adhesive layer that is adhered to the side surfaces of the lithium-ion battery.

In Example 31, the subject matter of any one or more of Examples 27-30 optionally further comprise an insulating layer at least partially surrounding the partial enclosure.

In Example 32, the subject matter of any one or more of Examples 21-31 optionally include wherein the plurality of side surfaces includes four side surfaces extending between the first end surface and the second end surface.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A battery device, comprising:
a lithium-ion battery comprising:
a first end surface;
a second end surface; and
a plurality of side surfaces extending longitudinally between the first end surface and the second end surface; and
a partial enclosure that surrounds the second end surface and the plurality of side surfaces, the partial enclosure defining an opening that at least partially exposes the first end surface, the partial enclosure comprising a copper tape and being configured to vent output of the lithium-ion battery during a thermal runaway event.

2. The battery device of claim 1, wherein the battery device is configured to be operatively coupled to a wearable electronic device.

3. The battery device of claim 2, wherein upon coupling of the battery device to the wearable electronic device, the opening of the partial enclosure is oriented such that the output of the lithium-ion battery can be vented in a direction away from a wearer of the wearable electronic device.

4. The battery device of claim 1, wherein the copper tape comprises an adhesive layer that is adhered to the side surfaces of the lithium-ion battery.

5. The battery device of claim 1, further comprising an insulating layer at least partially surrounding the partial enclosure.

6. The battery device of claim 1, wherein the plurality of side surfaces includes four side surfaces extending between the first end surface and the second end surface.

7. A wearable electronic apparatus, comprising:
an electronic device configured to be worn on a body of a user; and
a battery device configured to be operatively coupled to the electronic device and provide power to the electronic device, the battery device comprising:
a lithium-ion battery having a first end surface, a second end surface, and a plurality of side surfaces; and
a protective enclosure partially surrounding the lithium-ion battery, the protective enclosure surrounding the second end surface and the plurality of side surfaces, while leaving the first end surface at least partially exposed.

8. The wearable electronic apparatus of claim 7, wherein the protective enclosure comprises copper tape.

9. The wearable electronic apparatus of claim 7, wherein the protective enclosure comprises a ceramic cloth or panel.

10. The wearable electronic apparatus of claim 7, wherein the protective enclosure includes a material having a melting point of greater than 800 degrees Celsius.

11. The wearable electronic apparatus of claim 7, wherein the electronic device is a head-mounted device.

12. The wearable electronic apparatus of claim 11, wherein the head-mounted device comprises a heads-up display.

13. The wearable electronic apparatus of claim 11, wherein the head-mounted device comprises ski goggles.

14. The wearable electronic apparatus of claim 11, wherein the head-mounted device comprises glasses.

15. The wearable electronic apparatus of claim 7, wherein the electronic device is a wrist-mounted device.

16. The wearable electronic apparatus of claim 7, further comprising an insulating material at least partially surrounding the enclosure.

17. The wearable electronic apparatus of claim 7, further comprising electric leads, the electric leads connecting to the first end of the lithium-ion battery and the protective enclosure defines an opening that allows the electric leads to pass therethrough.

18. A wearable electronic apparatus comprising:
an electronic device configured to be worn on a body of a user;
a means for providing power to the electronic device; and
a means for containing and directionally venting away from the user of the device the gas or flames associated with a thermal runaway event from the means for providing power to the electronic device.

19. The wearable electronic apparatus of claim 18, wherein the electronic device comprises a head-mounted device.

20. The wearable electronic apparatus of claim 18, wherein the electronic device comprises a wrist-mounted device.
